(19) United States
(12) Patent Application Publication
(10) Pub. No.: US 2010/0102609 A1
(43) Pub. Date: Apr. 29, 2010

(54) Vehicle Seat Assembly

(76) Inventors: Thomas W. Confer, Greene, NY (US); Gregory W. Smiley, Greene, NY (US); David B. Howe, Binghamton, NY (US); Craig Cochran, Atlanta, GA (US); Mark Berkobin, Marietta, GA (US); Baker Whisnant, Atlanta, GA (US); Robert Holben, Roswell, GA (US); William Conway, Marietta, GA (US); Howard Scott Ryan, Skaneateles, NY (US); Douglas M. Russell, Syracuse, NY (US); David L. Fergot, Syracurse, NY (US)

Correspondence Address: QUARLES & BRADY LLP, 411 E. WISCONSIN AVENUE, SUITE 2040, MILWAUKEE, WI, 53202-4497, US

(21) Appl. No.: 12/606,298

(22) Filed: Oct. 27, 2009

Related U.S. Application Data
(60) Provisional application No. 61/109,348, filed on Oct. 29, 2008.

(51) Int. Cl. B60N 2/02; A47C 1/00; A47C 3/00; B60N 2/005; B66F 9/075

(52) U.S. Cl. 297/335; 187/222

(57) ABSTRACT

A lift truck includes a seat assembly having a first frame and a seat bottom pivotably mounted to the frame for pivotable movement between a standing operating position and a sitting operating position. The seat bottom has an upper facing surface for supporting an operator sitting on the seat bottom when the seat bottom is in the sitting operator position and a lower surface facing outwardly when the seat bottom is in the standing operator position for supporting an operator leaning against the seat bottom.

### CROSS-REFERENCE TO RELATED APPLICATION

This application claims the priority benefit of U.S. Provisional Patent Application No. 61/109,348 filed on Oct. 29, 2008, the entirety of which is fully incorporated herein by reference.

### STATEMENT CONCERNING FEDERALLY SPONSORED RESEARCH OR DEVELOPMENT

Not applicable.

### FIELD OF THE INVENTION

The present invention relates to vehicle seat assemblies, and more specifically to a seat assembly for use in a vehicle, such as a lift truck.

### BACKGROUND OF THE INVENTION

Lift trucks are designed in a variety of configurations each suitable to perform certain tasks. In some lift trucks, the operator is afforded the opportunity to assume different operating positions. For example, certain types of lift trucks, are designed to allow the operator to either sit or stand during operation. Operators often have position preferences when operating a lift truck. Some operators prefer to sit on a seat when operating the lift truck, while other operators prefer to stand or lean against a surface in the operator's compartment while operating the lift truck. Accommodating the preferences of these different operators is extremely difficult due to the design constraints of operator compartments in certain lift trucks, such as a narrow aisle, right angle stacking lift truck.

One known method for accommodating these operator preferences is to provide a seat assembly with a seat that pivots downwardly out of the way of the operator when the operator prefers to stand while operating the lift truck. This requires the seat be spaced sufficiently above the operator compartment floor to allow the seat to pivot downwardly without interference. As a result, height adjustment of the seat is limited for short operators or eliminated completed to simplify the seat assembly.

Therefore, while solutions are known for providing an operator with a choice of sitting or standing while operating a lift truck, these solutions are often unsatisfactory for all applications, complex, and/or difficult to install. The present invention addresses these issues.

### SUMMARY OF THE INVENTION

In one aspect of the invention, a lift truck is provided. The lift truck includes a seat assembly having a first frame and a seat bottom pivotably mounted to the frame for pivotable movement between a standing operating position and a sitting operating position. The seat bottom has an upper facing surface for supporting an operator sitting on the seat bottom when the seat bottom is in the sitting operator position and a lower surface facing outwardly when the seat bottom is in the standing operator position for supporting an operator leaning against the seat bottom.

These and other aspects of the invention will become apparent from the following description. In the description, reference is made to the accompanying drawings which form a part hereof, and in which there is shown a preferred embodiment of the invention. Such embodiment does not necessarily represent the full scope of the invention and reference is made therefore, to the claims herein for interpreting the scope of the invention.

### BRIEF DESCRIPTION OF THE DRAWINGS

FIG. 1 is a perspective view of a lift truck including a seat assembly constructed in accordance with the present invention with the seat assembly configured for a sitting operation position;

FIG. 2 is a perspective view of the lift truck of FIG. 1 with the seat assembly configured for a standing operation position;

FIG. 3 is a front perspective view of the seat assembly of the lift truck of FIG. 1;

FIG. 4 is cross sectional view of the sea assembly along line 4-4 of FIG. 1;

FIG. 5 is a rear view of the seat assembly of FIG. 1;

FIG. 6 is a front view of the seat assembly with the seat bottom and back rest removed;

FIG. 7 is a front perspective view of the rail frame of FIG. 5;

FIG. 8 is a front perspective view of the seat support frame of FIG. 6

FIG. 9 is a cross sectional view of the seat assembly along line 9-9 of FIG. 5;

FIG. 10 is a cross sectional view of the seat assembly along line 10-10 of FIG. 5;

FIG. 11 is a cross sectional view of the seat assembly along line 11-11 of FIG. 5;

FIG. 12 is a front view of the seat bottom of FIG. 3;

FIG. 13 is a top view of the seat bottom of FIG. 12;

FIG. 14. is a cross sectional view of the seat bottom along line 14-13 of FIG. 13;

FIG. 15 is a detailed cross sectional view of the seat assembly along line 15-15 of FIG. 3;

FIG. 16 is a detailed view of the seat assembly;

FIG. 17 is a detailed view of the seat assembly along line 17-17 of FIG. 16; and

FIG. 18 is a perspective view of the lift truck of FIG. 2 with the seat assembly having another embodiment of the sat bottom.

### DETAILED DESCRIPTION OF THE PREFERRED EMBODIMENT

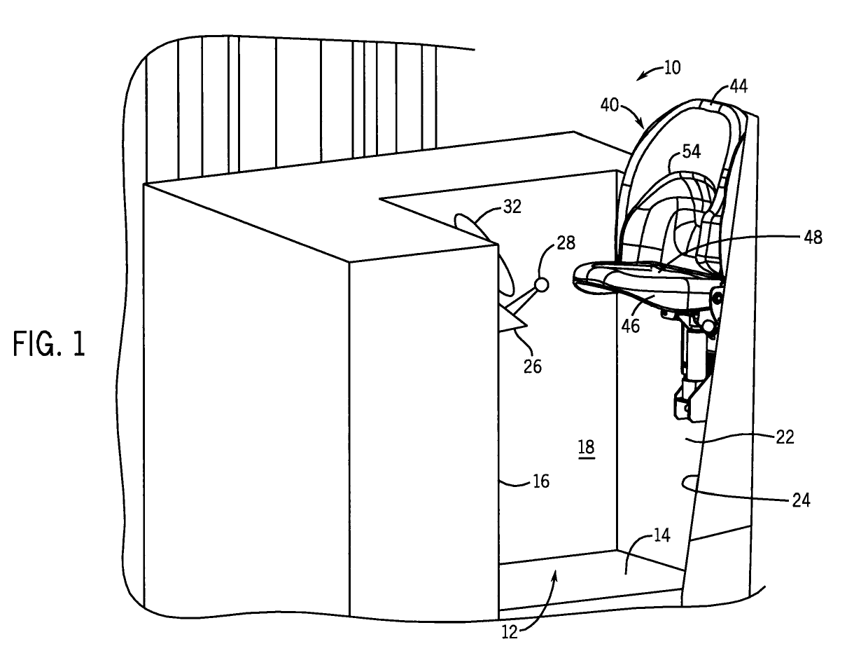

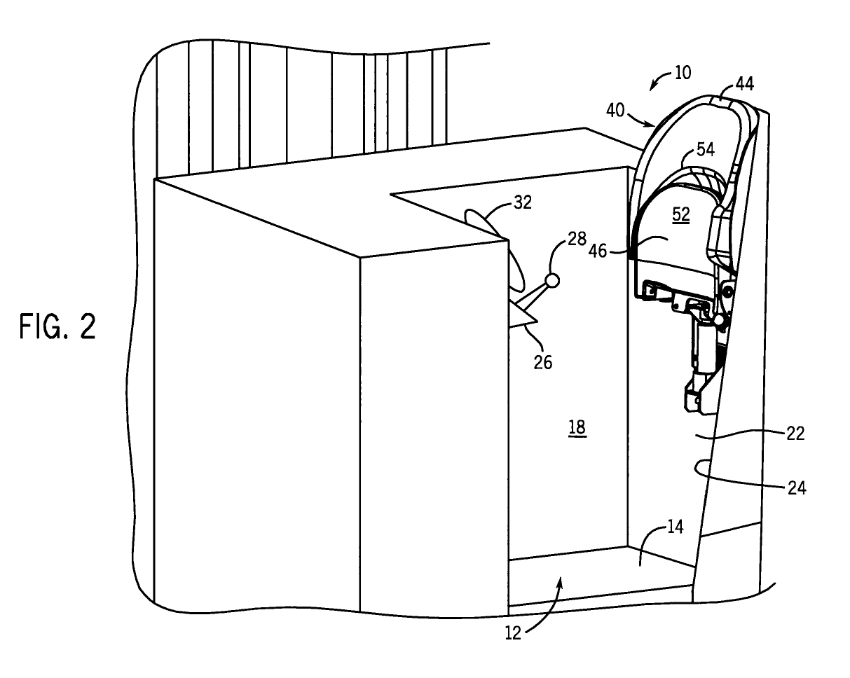

Referring now to the Figures, and more particularly to FIGS. 1 and 2, which shows the general arrangement of a representative material handling vehicle or lift truck 10 incorporating the present invention. The lift truck 10 includes an operator station comprising an operator station or compartment 12 constructed in accordance with the present invention is shown. The operator compartment 12 includes a platform 14 on which the operator stands and a plurality of walls 16, 18, 22, 24, defining the compartment. The compartment also contains an open back which affords the operator the easy ability to get on and off the lift truck. An operator console 26 is provided along an upper portion of the compartment. The operator console 26 contains openings which define the locations of the control handle 28 and steering wheel 32, within reach of the operator. (The control handle and steering wheel are not mounted to the console directly). In some fork lift configurations, the operator console 26 is provided adjacent forks such that the operator looks forward toward the forks while operating the vehicle 10. Here, as shown, the operator compartment 12 is provided in a “side stance” configuration.

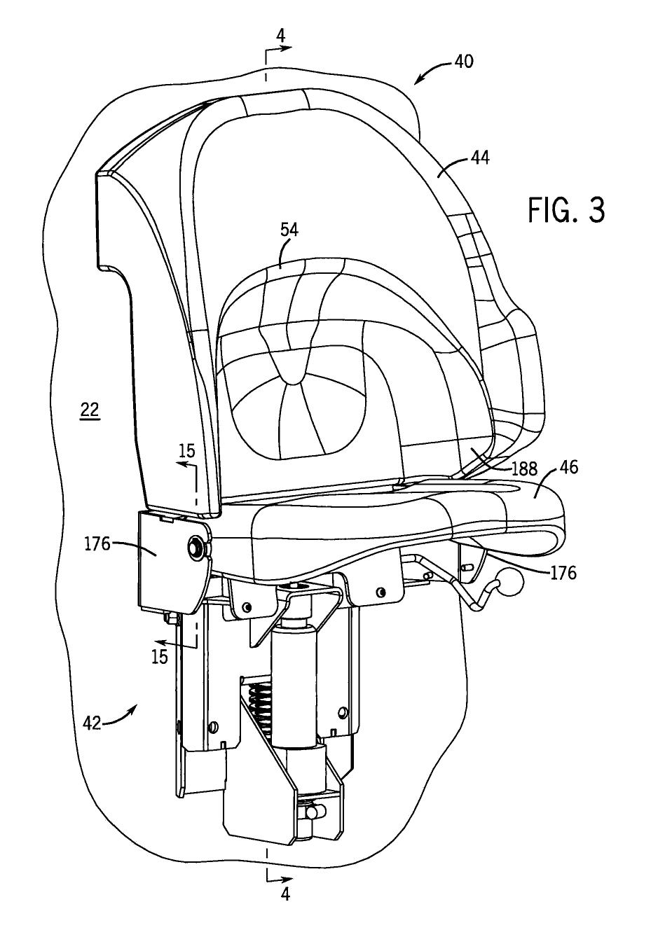

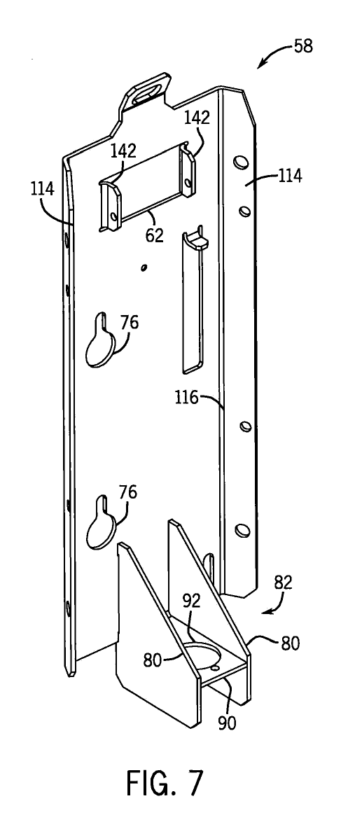

Referring now to FIGS. 1-7, a seat assembly 40 mounted to the vehicle 10 in the operator compartment 12 provides the operator with the option of operating the truck 10 while sitting or standing. The seat assembly 40 includes a height adjustable seat frame assembly 42 mounted directly to the truck 10. A seat back 44 mounted to the height adjustable seat frame assembly 42 supports the operator in either the sitting or standing position. A double-sided seat bottom 46 is pivotably mounted to the height adjustable seat frame assembly 42, and has an upper surface 48 that supports the operator while sitting and a lower surface 52 that supports the operator while standing. Advantageously, the seat back 44 includes a cut out 54 that receives the seat bottom 46 to maximize space in the operator compartment 12 when operating the truck 10 in a standing position.

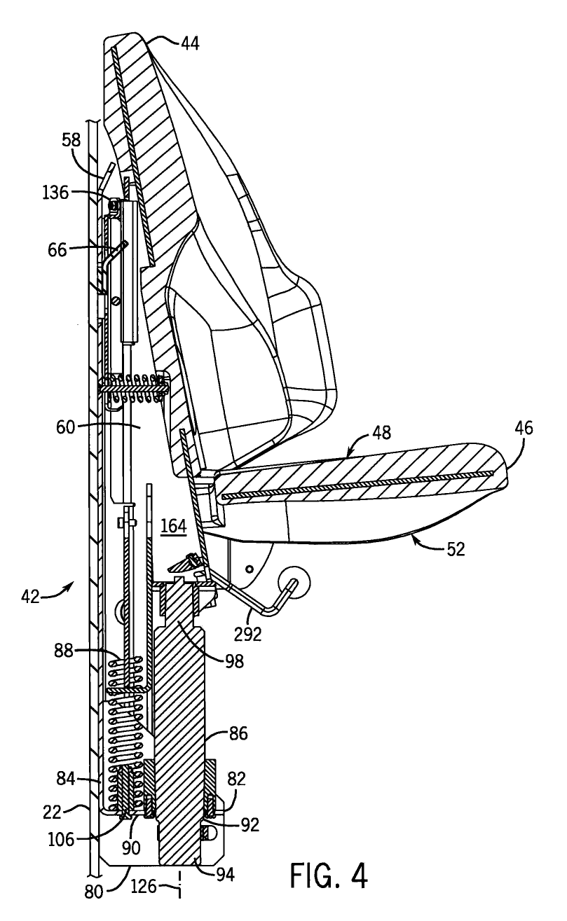

As shown in FIGS. 4-7, the height adjustable seat frame assembly 42 includes a substantially rectangular rail frame 58 fixed to the compartment wall 22 opposite the operator console 26 and a seat support frame 60 slidably mounted relative to the rail frame 58. A mounting slot 62 formed in the rail frame 58 between opposing longitudinal rail frame edges 64 receives a hook 66 extending from the compartment wall 22 to mount the rail frame 58 relative to the wall 22. Preferably, the upwardly extending hook 66 has angled side edges that engage the mounting slot 62 and guides the hook 66 into the slot 62 to secure the rail frame 58 against lateral movement.

Once mounted on the hook 66, the rail frame 58 is securely fixed to the compartment wall 22 by a bolt extending from the compartment wall 22 and through a key-shaped opening 76 formed through the rail frame 58. The bolt threadably engages a nut that is tightened against the rail frame 58 to securely fix the rail frame 58 to the compartment wall 22. The opening 76 is key-shaped to allow the rail frame 58 to be hung on the hook 66 with the bolt 74 and nut 78 thereon extending from the compartment wall 22. Two key-shaped openings 76 are provided through the rail frame 58 to accommodate two bolts 74. However, one or more bolts and corresponding openings to secure rail frame 58 to the compartment wall 22 can be provided without departing from the scope of the invention.

A cushion support 82 fixed to a lower portion 84 of the rail frame 58, such as by welding, supports a pneumatic cylinder 86 and compression spring 88 that cushion vertical movement of the seat support frame 60. The cushion support 82 includes a support plate 90 extending horizontally from the rail frame 58 and interposed between opposing side plates 80. An opening 92 formed through the support plate 90 receives a lower end 94 of the pneumatic cylinder 86 that extends downwardly through and past the support plate 90. An upper end 96 of a piston 98 extending into the pneumatic cylinder 86 is fixed to a bracket 104 fixed to the seat support frame 60. The pneumatic cylinder/piston assembly 86, 98 cushions vertical movement of the seat support frame 60 during truck operation when the seat bottom 46 is positioned at most any heights within a range of height adjustment. Advantageously, the side plates 80 extend downwardly past the support plate 90 and pneumatic cylinder lower end 94 to protect the downwardly extending lower end 94 of the cylinder 86 when the seat assembly 40 is not mounted in the operator compartment 12.

The compression spring 88, shown in FIG. 4, cushions vertical movement of the seat support frame 60 during truck operation when the seat support frame 60 is positioned at a lower height of the range of height adjustment. Moreover, the compression spring 88 provides a “soft landing” for the entire range of height adjustment and prevents bottoming out of the pneumatic cylinder/piston assembly 86, 98. Preferably, the compression spring 88 is a helical spring supported by the support plate 90 between the pneumatic cylinder 86 and rail frame 58 using a compressible retainer 106, such as formed by rubber, fixed to the support plate 90 and coaxial with the compression spring 88. A screw, or other elongated fastener, extending through the support plate 90 engages a lower portion of the compressible retainer 106 to fix the compressible retainer 106 relative to the compression spring. Advantageously, upon vertical compression of the compressible retainer 106, such as during cushioning of the seat support frame 60, the compressible retainer 106 expands radially to engage the compression spring 88 and retain the compression spring 88 in position to cushion downwardly vertical movement of the seat support frame 60.

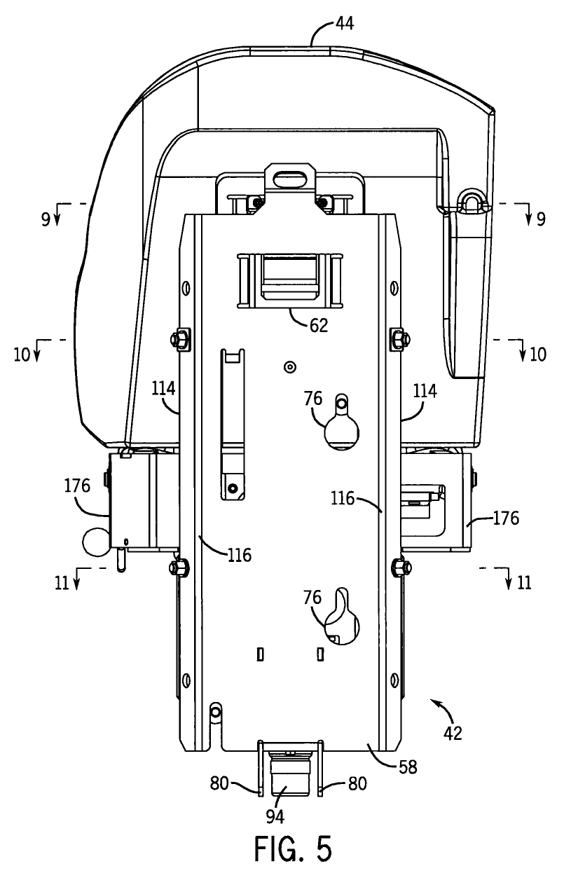

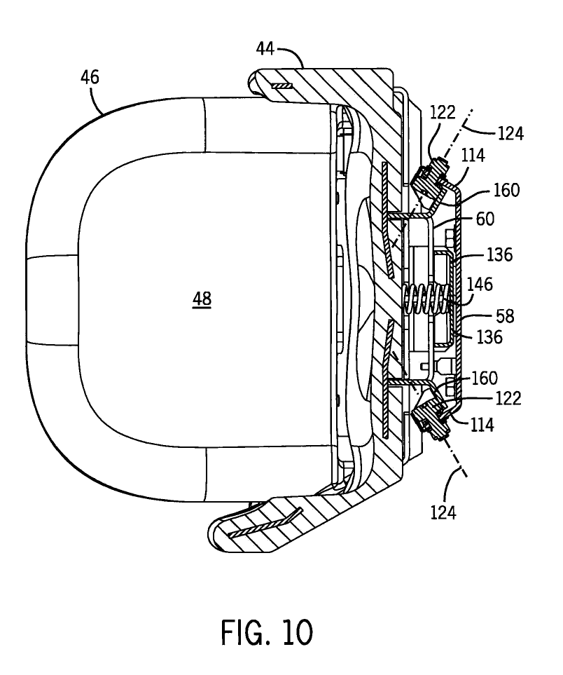

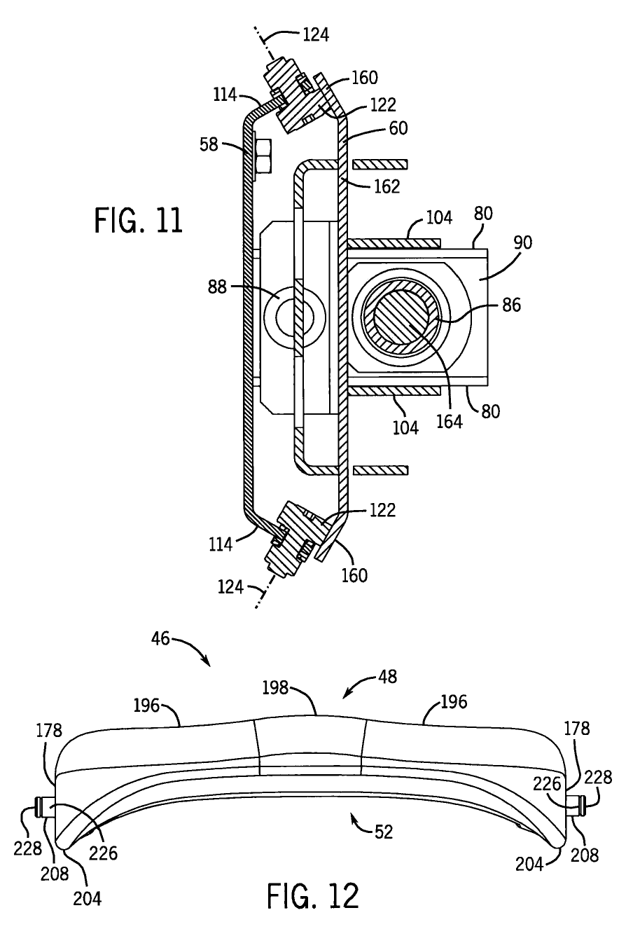

Referring now to FIGS. 5-7 and 9-11, rails 114 extending from each longitudinal edge 116 of the rail frame 58 into the operator compartment 12 support rollers 122 engaging the vertically adjustable seat support frame 60 to slidably couple the seat support frame 60 to the rail frame 58. The rails 114 form an acute angle A with the rail frame 58 to align the rotational axis 124 of the rollers 122, such that the axes 124 intersect the longitudinal axis 126 of the pneumatic cylinder 86, to minimize rotation of the seat support frame 60 about the pneumatic cylinder axis 126.

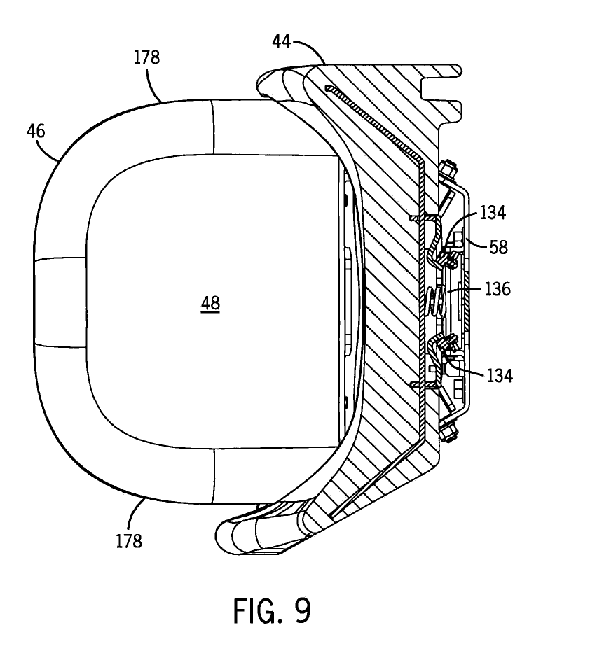

The seat support frame 60 is urged into engagement with the support rollers 122 by idler rollers 134 (shown in FIG. 9) rotatably mounted on a biased pivot plate 136 pivotally mounted to the rail frame 58. The pivot plate 136 pivots about a pin 138 extending between flanges 142 extending inwardly from opposing ends 144 of the mounting slot 62. A compression spring 146 fixed relative to the rail frame 58 by a pin 148 extending coaxially with the compression spring 146 urges a lower end 154 of the pivot plate 136 toward the rail frame 58. As a result, the idler rollers 134 mounted proximal an upper end 156 of the pivot plate 136 are urged into engagement with vertical rails 158 formed in the seat support frame 60 to urge the seat support frame 60 into engagement with the support rollers 122 and minimize backlash of the seat support frame 60 when the operator is not using the seat assembly 40.

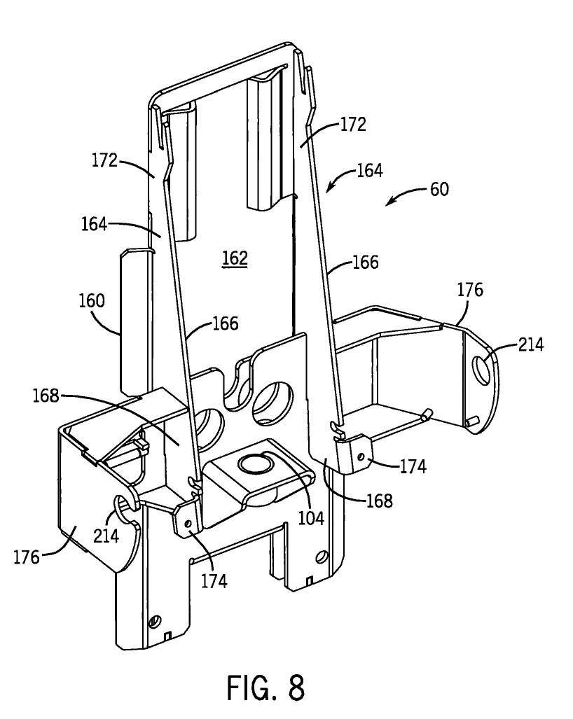

Referring to FIGS. 4-6 and 8-11, the vertically adjustable seat support frame 60 moves vertically relative to the rail frame 58 to adjust the height of the seat bottom 46 and seat back 44 relative to the compartment platform 14. The seat support frame 60 includes a seat support frame back 162 having perpendicular extending sidewalls 164. Forward facing edges 166 of the sidewalls 164 slope rearwardly from a forward most bottom 168 of the sidewalls 164 toward a rearward most top 172 of the sidewalls 164. Attachment wings 174 for fixing the seat back 44 to the seat support frame 60 extend outwardly from the edges 166 of the bottom 168 of the sidewalls 164. Bracket arms 176 for pivotally mounting the seat bottom 46 thereto extend outwardly from the sidewalls 164 and partially along the sides 178 of the seat bottom 46.

The seat back 44 abuts the forward edges 166 of the seat support frame back sidewalls 164 and is rigidly fixed relative to the seat support frame 60 by fasteners, such as bolts, extending through apertures 186 formed through the attachment wings 174. Other methods of fixing the seat back 44 to the seat support frame 60 can be used, such as welding, without departing from the scope of the invention. The cutout 54 formed in a lower portion 188 of the seat back 44 conforms to the shape of the seat bottom 46 and receives the seat bottom 46 when the seat bottom 46 is pivoted upwardly to a standing operating position (shown in FIG. 2) for operating the truck 10 in a standing position.

Side rails 160 extending rearwardly from sidewalls 164 of the seat support frame back 162 engage the support rollers 122 mounted on the rail frame rails 114. The side rails 160 are aligned parallel to the axes 124 of rotation of the support rollers 122 to engage the outer diameter rolling surface of each support roller 122.

The seat bottom 46 is pivotally fixed to the seat support frame 60 for movement between the standing operating position and a sitting operating position (shown in FIG. 1). In the standing operating position, the seat bottom 46 is pivoted upwardly from the sitting operating position and received in the cutout 54 formed in the seat back 44. Advantageously, receiving the seat bottom 46 in the cutout 54 formed in the seat back 44 increases the space inside the operator compartment 12 during standing operation of the truck 10. In the sitting operating position, the seat bottom 46 is pivoted downwardly from the standing operating position and extends to provide a seat for the operator to sit on while operating the truck 10.

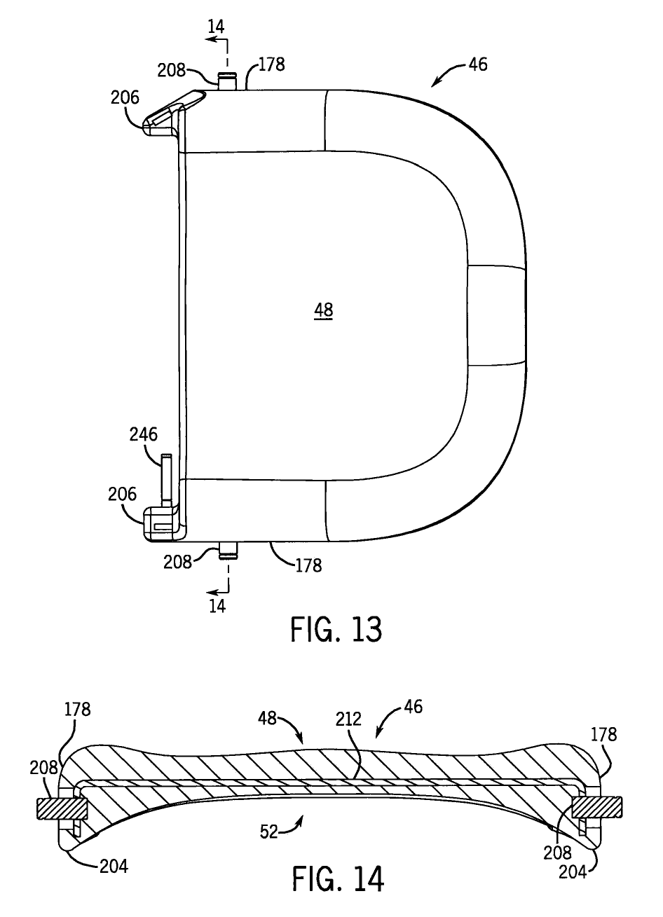

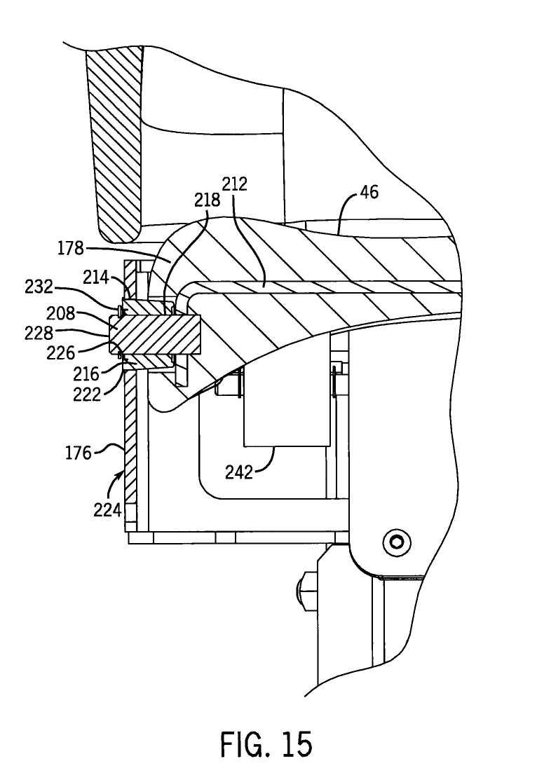

As shown in FIGS. 12-15, the seat bottom 46 includes the cushioned upper surface 48, on which the operator sits, and the cushioned lower surface 52, against which the operator leans. The cushion in the seat bottom 46 is provided using materials known in the art, such as urethane foam, and the like. In a preferred embodiment, the upper surface 48 is contoured having a pair of depressions 196 spaced inwardly from the seat bottom sides 178 and separated by a crown 198 to provide a comfortable surface for sitting when the seat bottom 46 is in the sitting operating position. The lower surface 52 includes ridges 204 along the seat bottom sides 178 which extend into the operator compartment when the seat bottom 46 is in the standing operating position. Advantageously, the ridges 204 cushion the operator's hips allowing for a smaller seat bottom to minimize the space requirements of the seat assembly 40. Stops 206 extending rearwardly from the seat bottom 46 engage the seat back 44 when the seat bottom 46 is in the sitting operating position.

The seat bottom 46 pivots about a pair of coaxial pins 208 extending outwardly from the seat bottom sides 178. Preferably, the pins 208 are secured to a seat base 212 disposed in the seat bottom 46 to rigidly fix the pins 208 to the seat bottom 46. The pins 208 extend into openings 214 formed in bracket arms 176 extending outwardly from the seat support frame sidewalls 164 of the seat support frame 60 and around the sides 178 of the seat bottom 46. A flanged bushing 216 disposed in each opening 214 includes an aperture 218 through which one of the pins 208 extend. The flange 222 of the bushing 216 engages an outwardly facing surface 224 of each bracket arm 176. An annular groove 226 is formed proximal the distal end 228 of each pin 208 and receives a clip, or e-style retainer ring 232, to prevent the bushing 216 from slipping out of the opening 214. Preferably, one of the openings 214 is open, i.e. slotted, to an end of the bracket arm 176 to simplify mounting the seat bottom 46 to the bracket arms 176.

The seat bottom 46 is biased toward the standing operating position and the sitting operating position by a horseshoe-shaped spring 242 having one end 244 pivotally coupled to a pin 246 extending inwardly from one of the stops 206 extending rearwardly from the seat bottom 46. An opposing end 248 of the horseshoe-shaped spring 242 is pivotally fixed to the seat support frame 60. Preferably, the length of the horseshoe-shaped spring 242 provides over center conditions when the seat bottom 46 is in the standing operating position and the sitting operating position. Advantageously, in the standing operating position shown in FIG. 2, the first over center condition locks the seat bottom 46 in the standing operating position. Likewise, in the sitting operating position shown in FIG. 1, the second over center condition locks the seat bottom 46 in the sitting operating position. The first and second over center positions are easily overcome by the operator grasping the seat bottom 46 and urging the seat bottom 46 toward the desired operating position.

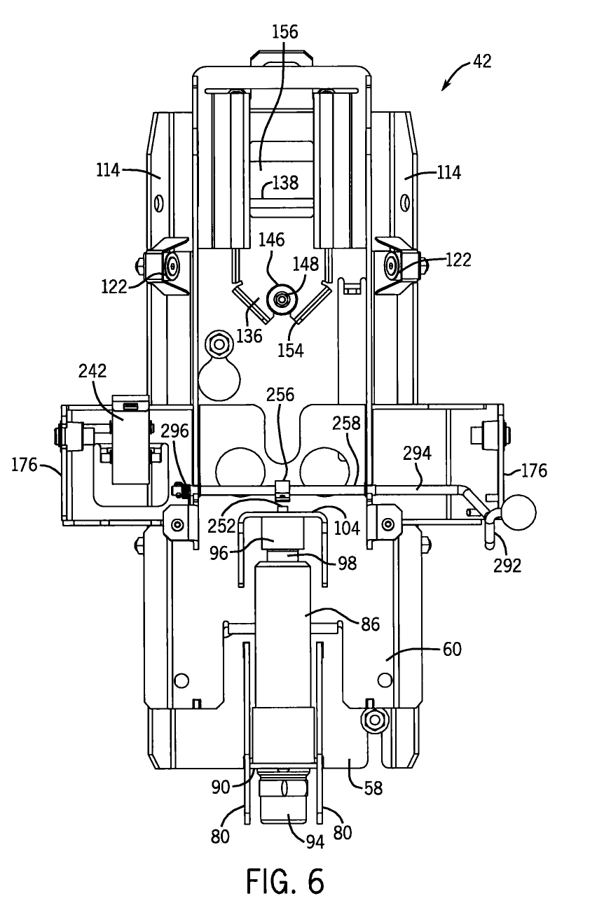

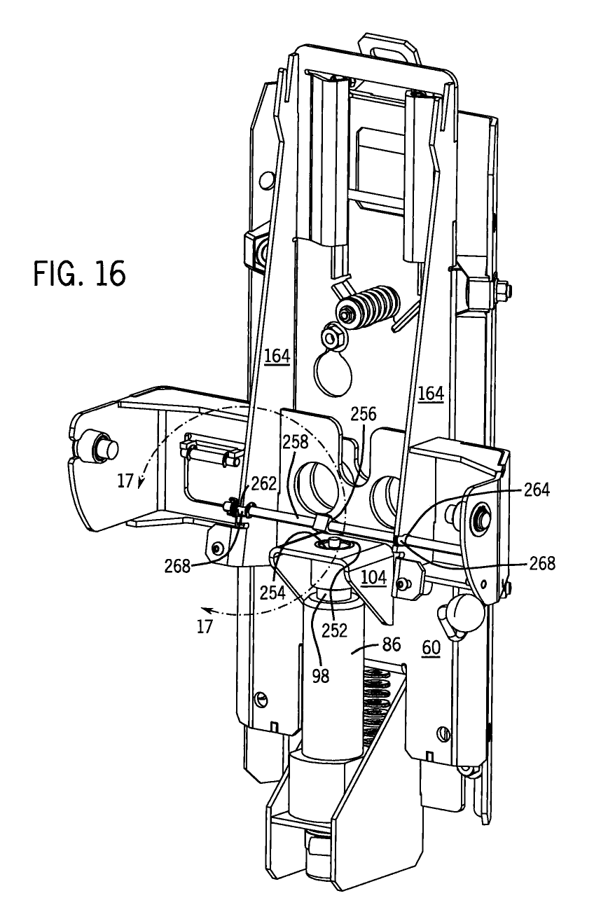

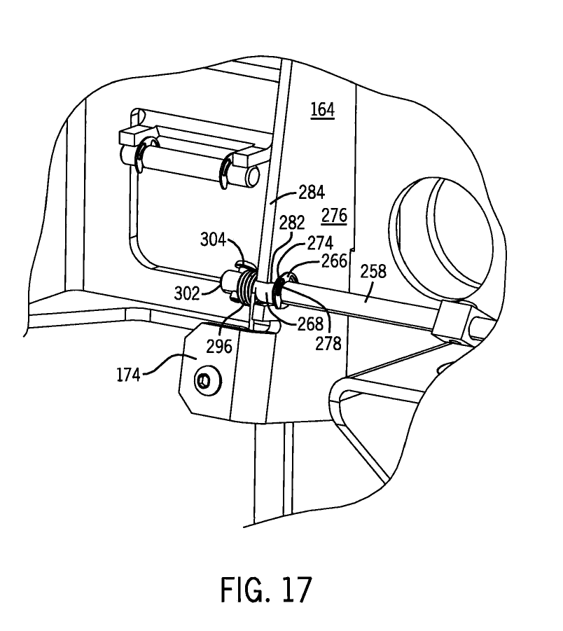

Referring to FIGS. 6, 16, and 17, the seat support frame 60 is vertically adjusted by allowing air to enter or exit the pneumatic cylinder 86 by a relief valve 252 disposed at an end 254 of the piston 98 extending through the bracket 104 fixed to the seat support frame 60. The relief valve 252 is actuated by a cam 256 mounted on a shaft 258 extending beneath the seat bottom 46 and over the pneumatic cylinder 86. The shaft 258 extends through a pair of coaxial openings 262, 264 formed through the seat support frame sidewalls 164. Preferably, flanged bushings 268 disposed in each opening 262, 264 includes an aperture 272 through which the shaft 258 extends. The flange 274 of each bushing 268 engages an inwardly facing surface 276 of the adjacent sidewall 164. An annular groove 278 formed in the shaft 258 proximal each bushing flange 274 receives a clip, or e-style retainer ring 266, to prevent the bushings 268 from slipping axially out of the openings 262, 264. Preferably, a slot 282 extends from each of the openings 262, 264 in the sidewalls 164 to the forward edge 284 of each sidewall 164 to simplify installing the shaft 258. The bushings 268 are sized to have a larger outer diameter than the width of the slots 282 to prevent from bushings 286 from radially slipping out of the openings 262, 264.

A seat height adjustment lever 292 extends radially from one end 294 of the shaft 258 and is movable between an adjustment position and a non-adjustment position. In the adjustment position, the shaft 258 is rotated to engage the cam 256 with the relief valve 252 allowing vertical adjustment of the seat support frame 60, and thus the seat bottom height, relative to the operator compartment floor 14. In the non-adjustment position, the cam 256 is disengaged from the relief valve 252. In the present application, the operator pulls up on the seat height adjustment lever 292 to move the lever 292 toward the adjustment position.

An anti-rattle helical spring 296 wraps around the shaft 258 and axially biases the shaft 258 to inhibit the shaft 258 from moving axially through the openings 262, 264 once installed. The anti-rattle spring 296 is disposed between an end 302 of the shaft 258 and the adjacent sidewall 164. One end of the spring 296 is fixed to the shaft 258, such as by a radially extending screw 304 threadably engaging a threaded aperture formed in the shaft 258. An opposing end of the helical spring 296 engages one of the attachment wings 174 to rotatively bias the seat height adjustment lever 292 extending from the shaft 258 toward the non-adjustment position. Advantageously, the biasing helical spring 296 also provides smooth articulation of the seat height adjustment lever 252 between the non-adjustment position to the adjustment position.

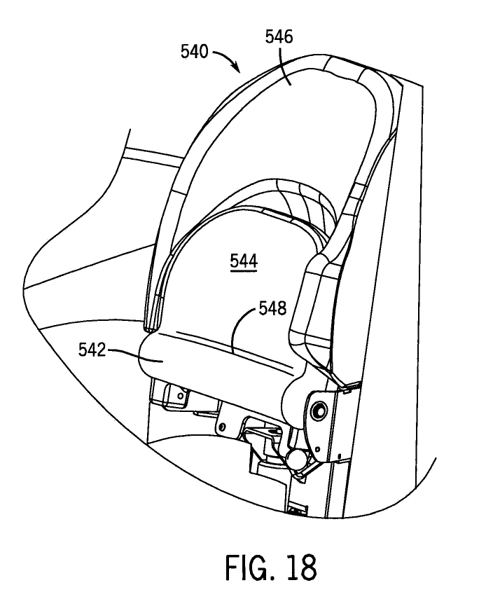

In another embodiment shown in FIG. 18, the seat assembly 540 is substantially identical to the seat assembly 40 described above, with the exception of a bump 542 formed at a proximal edge of the seat bottom lower surface 544. The bump 542 extends into the lift truck operator compartment when the seat bottom 546 is in the standing operation position to provide the operator with a short horizontal surface 548 to rest on when operating the truck in a standing position.

In yet another embodiment, the seat assembly swivels about a vertical axis allowing an operator to adopt different sitting positions, such as during vehicle travel or stacking operations. Preferably, the seat frame assembly is swivably mounted relative to the operator compartment to swivel about the longitudinal axis of a pneumatic cylinder cushioning at least a portion of the seat frame assembly, such as the pneumatic cylinder 86 in the embodiment shown in FIG. 4. In the swiveling embodiment, the seat frame can be mounted directly to the floor independent of the operator compartment walls allowing the entire frame assembly to swivel. Alternatively, an intermediate frame member slidably mounting a seat support frame relative to a rail frame or the rail frame relative to the operator compartment wall can be provided to swivably mount the seat frame assembly.

In yet another embodiment, the seat assemblies 40, 540 shown in FIGS. 2 and 18 are provided without the horseshoe-shaped spring 242 (shown in FIG. 6). The seat bottom 46, 544 pivots about the pair of coaxial pins 208 (shown in FIGS. 12-15) spaced forwardly from a rear edge of the seat bottom 46, 544. Advantageously, the seat bottom 46, 544 pivots upwardly and rearwardly toward the standing operating position and past a vertical plane extending through a pivot axis of the pins 208. By pivoting the seat bottom 46, 544 rearwardly past the vertical plane extending through the pivot axis of the pins 208, the weight of the seat bottom 46, 544 holds the seat bottom 46 in the standing operating position without the need of a latch, biasing spring, or other mechanism.

Although the invention has been described specifically for use in a lift truck or material handling vehicle, it will be apparent that the seat assembly can be useful in any number of vehicles or operator compartments. While there has been shown and described what are at present considered the preferred embodiments of the invention, it will be obvious to those skilled in the art that various changes and modifications can be made therein without departing from the scope of the invention defined by the appended claims.

We claim:

1. A seat assembly comprising:
a first frame;
a seat bottom pivotably mounted to said frame for pivotable movement between a standing operating position and a sitting operating position, said seat bottom having an upper surface facing upwardly for supporting an operator sitting on said seat bottom when said seat bottom is in said sitting operator position and a lower surface facing outwardly when said seat bottom is in said standing operating position for supporting an operator leaning against said seat bottom.

2. The seat assembly as in claim 1, including a seat back mounted to said frame, said seat back including a cut out which receives said seat bottom in said standing operating position.

3. The seat assembly as in claim 1, in which said lower surface of said seat bottom includes ridges extending from opposing sides of said seat bottom away from said upper surface for cradling said operator when said seat bottom is in said standing operating position.

4. The seat assembly as in claim 1, in which a biasing spring biases said seat bottom toward said standing operating position.

5. The seat assembly as in claim 4, in which said biasing spring has a first overcenter position which holds said seat bottom in said sitting operator position.

6. The seat assembly as in claim 5, in which said biasing spring has a second overcenter position which holds said seat bottom in said standing operator position.

7. The seat assembly as in claim 1, including a second frame slidably mounted relative to said first frame; and
rollers interposed between said first frame and said second frame slidably supporting said first frame relative to said second frame, in which each of said rollers rotate about an individual axis of rotation, and a plurality of the individual axes of rotation intersect a single axis extending substantially orthogonal to said plurality of the individual axes of rotation.

8. A seat assembly comprising:
a first frame;
a seat bottom pivotably mounted to said frame for pivotable movement between a standing operating position and a sitting operating position;
a second frame slidably mounted relative to said first frame; and
rollers interposed between said first frame and said second frame slidably supporting said first frame relative to said second frame, in which each of said rollers rotate about an individual axis of rotation, and a plurality of the individual axes of rotation intersect a single axis extending substantially orthogonal to said plurality of the individual axes of rotation.

9. The seat assembly as in claim 8, in which said seat bottom has an upper surface facing upwardly for supporting an operator sitting on said seat bottom when said seat bottom is in said sitting operator position and a lower surface facing outwardly when said seat bottom is in said standing operating position for supporting an operator leaning against said seat bottom.

10. The seat assembly as in claim 8, in which a cushioning mechanism cushions slidable movement of said first frame relative to said second frame, and said cushioning mechanism defines said single axis.

11. The seat assembly as in claim 10, in which said cushioning mechanism is a pneumatic cylinder assembly.

12. The seat assembly as in claim 11, in which a compression spring interposed between said first frame and said second frame inhibits said pneumatic cylinder assembly from bottoming out.

13. The seat assembly as in claim 12, in which said compression spring is retained relative to said second frame by a compressible retainer which expands outwardly to engage said compression spring and retain said compression spring in position.

14. The seat assembly as in claim 11, in which said pneumatic cylinder assembly includes a relief valve allowing air into and out of said pneumatic cylinder assembly to adjust a length of said cylinder assembly.

15. The seat assembly as in claim 12, including a shaft extending through openings in said first frame past said pneumatic cylinder assembly, a cam mounted on said shaft engages said relief valve to open said relief valve upon rotation of said shaft, and a biasing spring that rotatably biases said shaft to urge said cam out of engagement with said relief valve and inhibit shaft rattle.

16. The seat assembly as in claim 15, in which at lease one of said openings is slotted to a frame edge, and said shaft extends through a bushing received in said at least one of said opening, wherein said bushing does not fit through said slot.

17. A lift truck comprising a seat assembly as in claim 7.

18. A lift truck as in claim 18, in which a hook extending from a wall of said lift truck is received in an opening formed in said second frame to mount said seat assembly in said lift truck.

19. A lift truck comprising a seat assembly as in claim 8.

20. A lift truck as in claim 20, in which a hook extending from a wall of said lift truck is received in an opening formed in said second frame to mount said seat assembly in said lift truck.
